(19) United States
(12) Patent Application Publication
(10) Pub. No.: US 2017/0215623 A1
(43) Pub. Date: Aug. 3, 2017

(54) COOKING APPARATUS

(71) Applicant: The Decor Corporation Pty Ltd, Scoresby (AU)

(72) Inventor: Jim Samartgis, Eltham (AU)

(21) Appl. No.: 15/424,169

(22) Filed: Feb. 3, 2017

(30) Foreign Application Priority Data
Feb. 3, 2016 (AU) 2016900351

(51) Int. Cl. A47J 27/00; A47J 36/02; A47J 36/06

(52) U.S. Cl. CPC A47J 27/002; A47J 36/06; A47J 36/027

(57) ABSTRACT

A cooking apparatus for the cooking of bacon in a microwave oven, the apparatus including a base member and a lid which is removably co-operable therewith, wherein: the base member including a bottom and a peripheral side wall extending upwardly therefrom, the bottom of the base member having an inside cooking surface being of an arcuate shape when viewed in end elevation such that the cooking surface is higher at a centre portion of the arcuate shape than at an end portion, such that liquids can run from the centre portion to the end portion, the cooking surface of the base member further including a plurality of spaced-apart ribs extending substantially transversely thereof; and wherein the lid includes a top and a peripheral side wall extending therefrom, wherein the lid, when viewed in end elevation, curves from the top to the peripheral side wall.

### CROSS-REFERENCE TO RELATED APPLICATIONS

This application claims the benefit of Australian Patent Application No. 2016900351, filed Feb. 3, 2016, which is hereby incorporated by reference in its entirety for all purposes.

### FIELD OF THE INVENTION

The present invention relates, in general terms, to an apparatus or utensil to be used for the cooking, in a microwave oven or microwave cooker of any known type, of bacon and the like food products.

### BACKGROUND OF THE INVENTION

Bacon is a popular foodstuff, used nowadays as an important part/constituent of a variety of different meals. By way of example consider bacon-and-eggs—a popular part of any breakfast menu—not to mention bacon as part of the popular lunch-time/anytime sandwich known generically as “BLT” (standing for bacon, lettuce and tomato). The quality and enjoyment of any meal which includes bacon as a part thereof is largely dependent upon how the bacon is cooked. If it's not cooked “properly”, then the meal loses at least part of its attraction. This applies whether the bacon is over-cooked, or under-cooked for that matter.

Conventional means and methods for the cooking of bacon, using conventional cooking apparatus such as a gas or electric oven or a hot plate, have a number of benefits on the one hand, but on the other hand suffer from a number of disadvantages in terms of ensuring “proper” cooking, cleaning cookware after cooking is completed and the meal finished, and ease of cooking, etc. As an alternative, there have been proposed a number of pieces of equipment intended for use in a microwave oven or microwave cooker, using microwave radiation. Whether a conventional cooking apparatus or a microwave cooking apparatus is employed, however, problems have been encountered in terms of ensuring consistent appearance, taste and, perhaps more importantly, texture of the thus cooked bacon.

The present invention seeks to overcome the problems and disadvantages associated with the traditional cooking apparatus by providing an apparatus, for use in a microwave oven or cooker, for the cooking of foodstuff including bacon, with the end result being an edible product of a consistent appearance, taste and texture. The apparatus in accordance with the present invention effects its desired function in an efficient and clean way, and lends itself to ready repetition, thus allowing for the user to achieve a consistency of result in terms of the end product.

In accordance with the present invention, therefore, there is provided an cooking apparatus for the cooking of bacon in a microwave oven, the apparatus including a base member and a lid which is removably co-operable therewith, wherein: the base member including a bottom and a peripheral side wall extending upwardly therefrom, the bottom of the base member having an inside cooking surface being of an arcuate shape when viewed in end elevation such that the cooking surface is higher at a centre portion of the arcuate shape than at an end portion, such that liquids can run from the centre portion to the end portion, the bottom of the base member further including a plurality of spaced-apart ribs extending substantially transversely thereof; and wherein the lid includes a top and a peripheral side wall extending therefrom, wherein the lid, when viewed in end elevation, curves from the top to the peripheral side wall.

### BRIEF DESCRIPTION OF THE DRAWINGS

In order that the invention may be more clearly understood and put into practical effect, reference will now be made to a preferred embodiment of a cooking apparatus in accordance with the invention. The ensuing description is given by way of non-limitative example only and is with reference to the accompanying drawings, wherein:

FIG. 1 is a top perspective view of a preferred embodiment of a cooking apparatus in accordance with the present invention;

FIG. 2 is an exploded view of the cooking apparatus of FIG. 1, with the principle parts shown separated;

FIG. 3 is a top view of the cooking apparatus of FIG. 1;

FIG. 4 is a sectional view taken along the line 4-4 of FIG. 3;

FIG. 5 is an upper perspective view of the lid of the cooking apparatus shown in FIG. 1;

FIG. 6 is a lower perspective of the lid of FIG. 5;

FIG. 7 is a left side view of the lid of FIG. 5;

FIG. 8 is a front view of the lid of FIG. 5;

FIG. 9 is an upper perspective view of the base of the cooking apparatus;

FIG. 10 is a lower perspective view of the base of FIG. 9;

FIG. 11 is a side view of the base of FIG. 9; and

FIG. 12 is a front view of the base of FIG. 9.

### DETAILED DESCRIPTION OF PREFERRED EMBODIMENTS

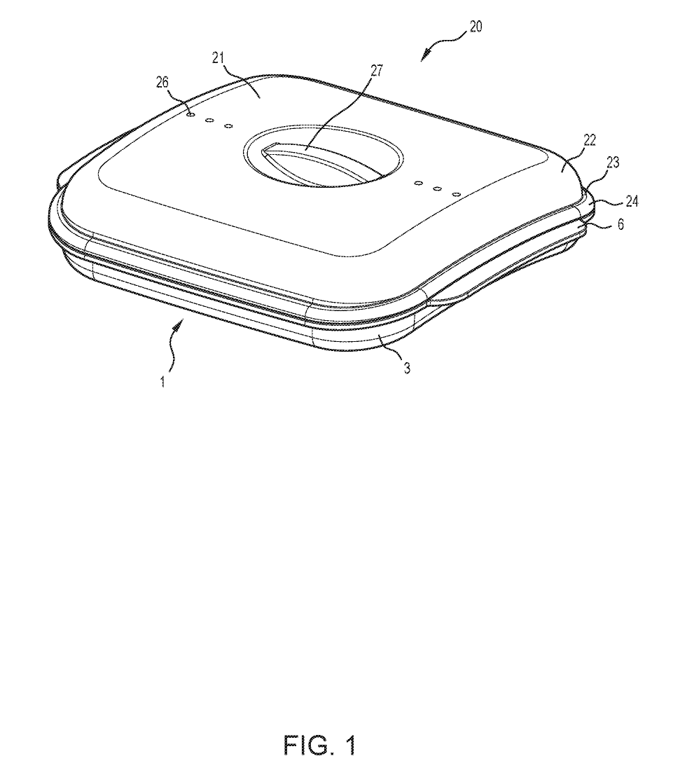

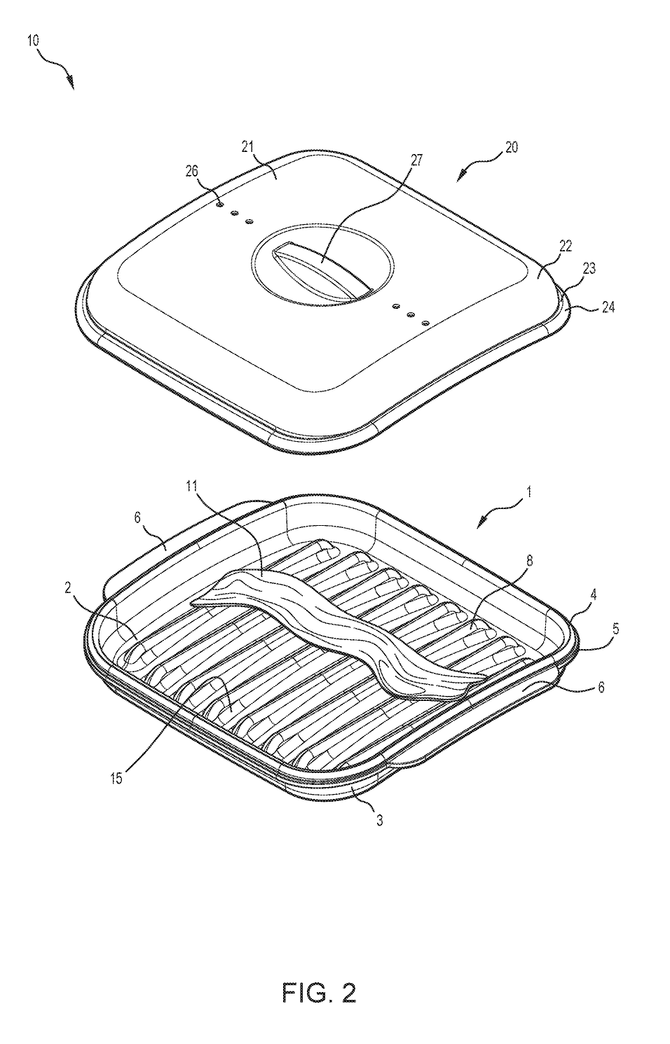

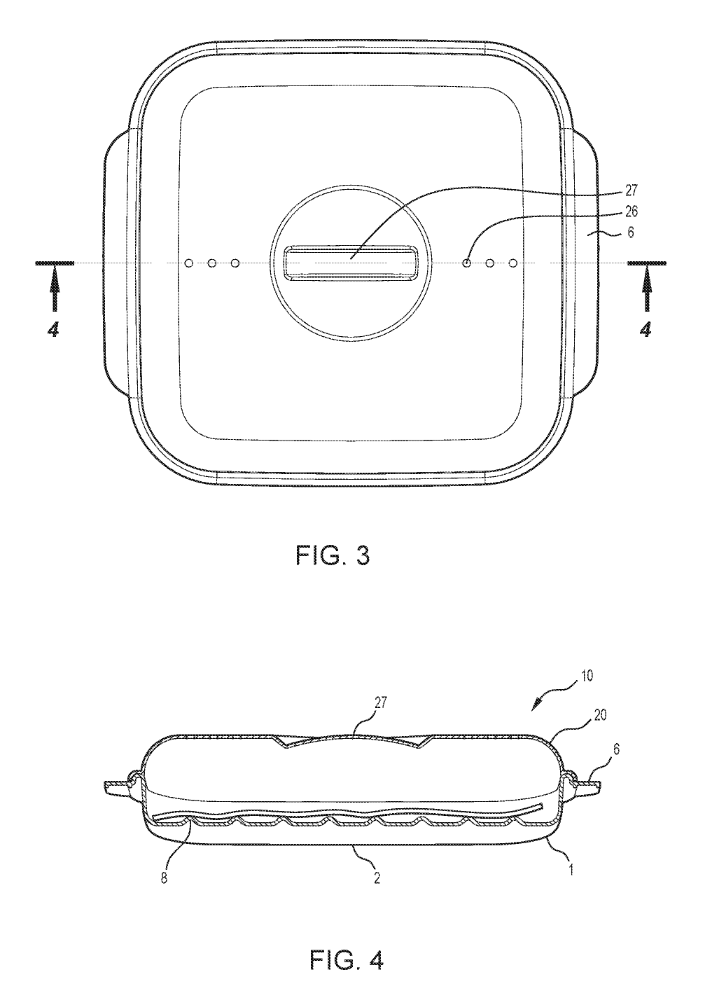

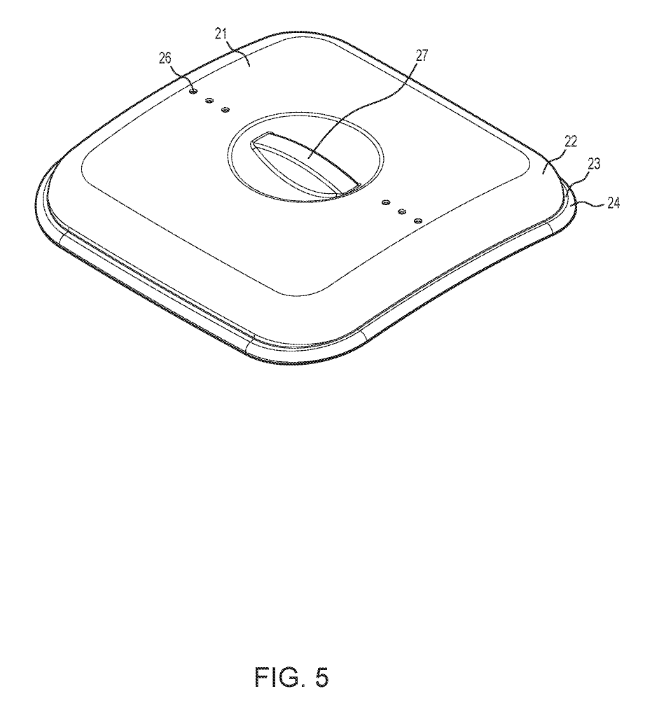

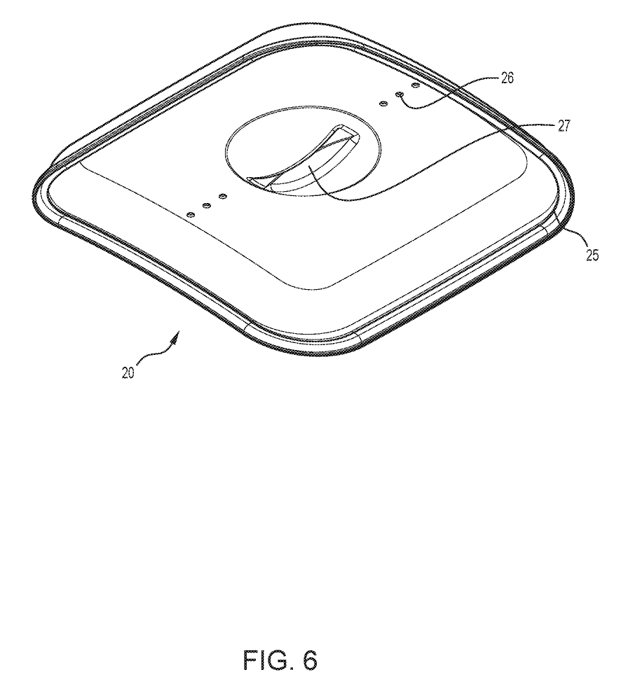

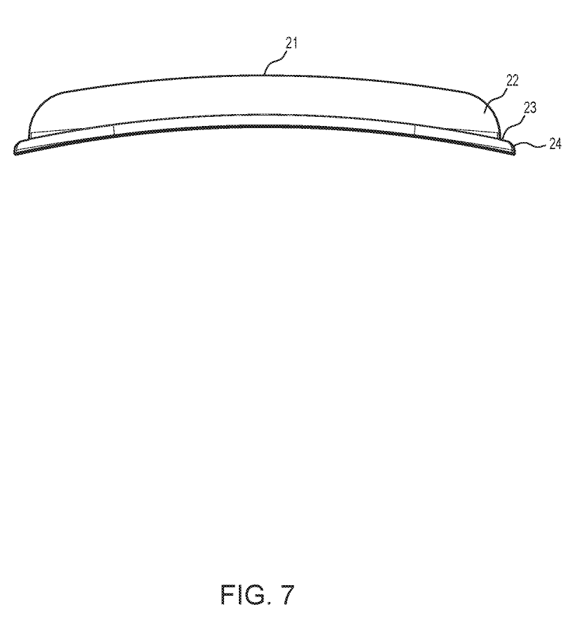

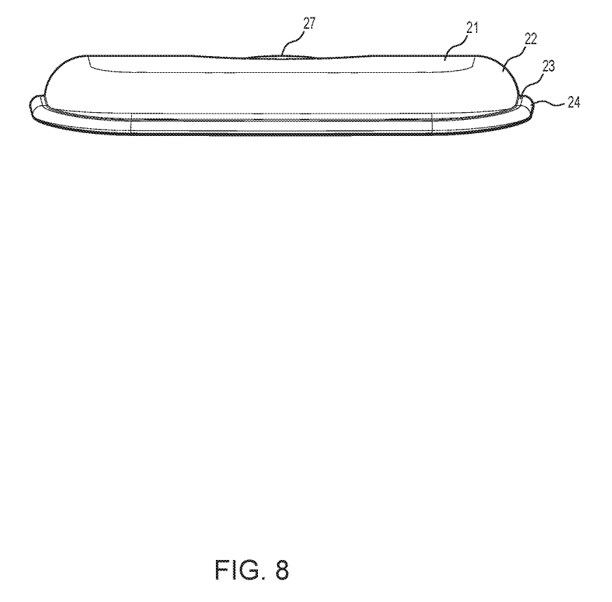

As shown in the drawings, and this with particular regard to FIGS. 1 and 2, a cooking apparatus 10 in accordance with the present invention includes two principal components, namely a base member 1 and a lid 20. The apparatus is used to cook food products in a microwave and the food product referred to herein by way of example is bacon 11.

Both the base 1 and the lid 20 are of an integral construction and preferably are formed from a suitable plastics material, although it should be understood that the actual material of construction is not of the essence of the invention. Preferably these components will be constructed from a material that is transparent to microwave radiation, as the microwave radiation penetrates the base and lid in order to cook the food items.

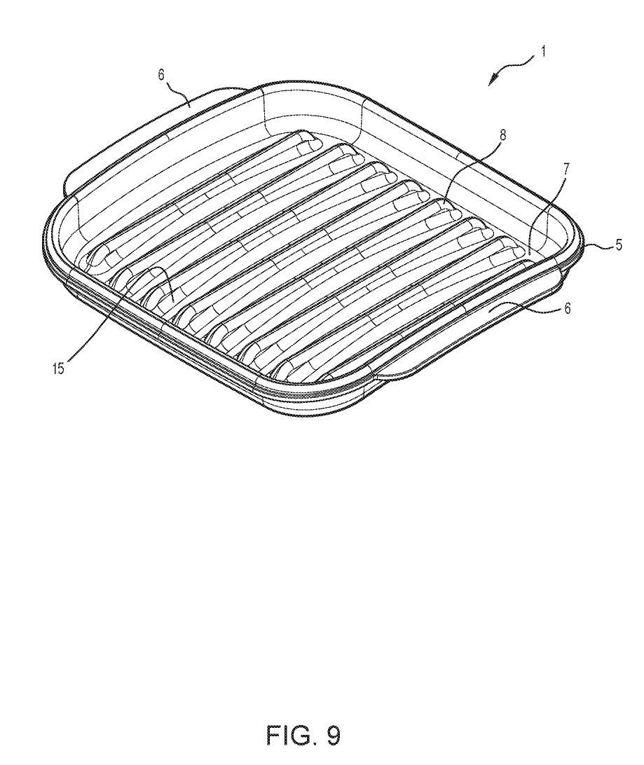

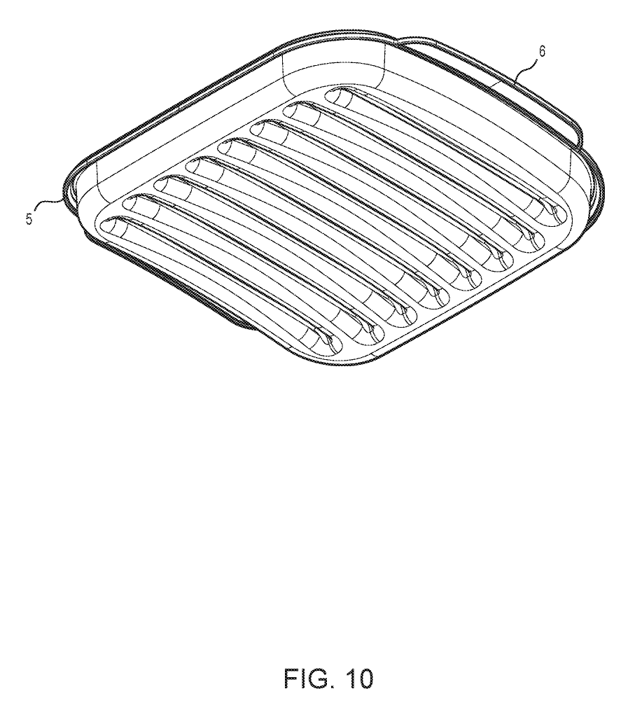

In the preferred embodiments shown the base 1 is of a substantially oblong shape (when viewed in plan—see FIGS. 2, 9 and 10). However it should be understood that the actual form or shape of that base 1 (when viewed in plan) is not of the essence of the invention.

The base 1 includes a bottom 2 and an upwardly-extending peripheral or circumferential side wall 3. The side wall 3 terminates, at the upper end thereof which is spaced from the bottom 2, in a peripheral and substantially downwardly-extending lip 4, which in turn terminates in a peripheral flange 5 extending laterally therefrom. The flange 5 includes, as shown, at least one pair of opposed extensions or handle means 6, to facilitate handling—as in picking-up, depositing or carrying—of the overall apparatus.

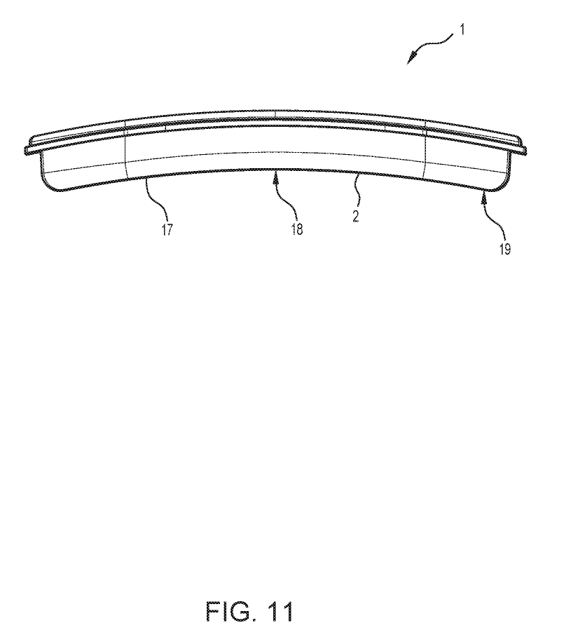

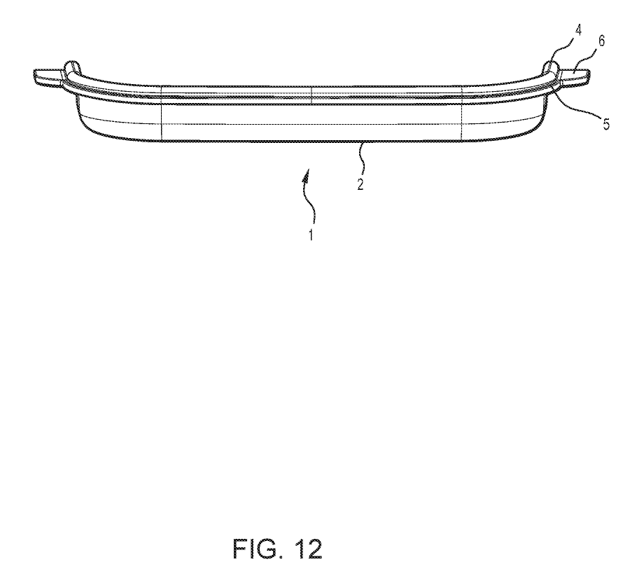

As shown in the drawings (see for example FIG. 11) the bottom 2 of the base 1 has an inside cooking surface 15 that is not flat over the entire surface thereof, but rather has an arcuate or curved shape (arc 17) when viewed in end elevation. The curved, arcuate shape may be a result of the bottom 2 itself being of an arcuate shape (as is illustrated in the preferred embodiment) or alternatively the underneath surface of the bottom 2 may be flat (to lie flat against a horizontal surface) while the cooking surface 15 may still be arcuate. This would include a flat bottom supporting an arcuate upper cooking surface that faces the inside of the cooking apparatus. The arcuate cooking surface is thereby defined by being higher at a centre portion 18 of the arcuate shape than at an end portion 19,

This arcuate or curved shape allows fat, grease or oil which might be generated during cooking, as for example exuded from the bacon housed and being cooked in the apparatus, to travel under gravity along the curved shape bottom 2 towards the sides or edges of the base 1, to be collected in a gutter 7 which extends along at least two opposed sides or edges of that base 1.

The bottom 2 of the base 1 further includes a plurality of upwardly-extending, spaced-apart, ribs 8 extending laterally thereof and in the same direction as the arc 17 defined by the arcuate shape of the cooking surface. The ribs 8 decrease in height from the outside (end portion 19 of arc) towards the central part (centre portion 18 of arc) of the bottom 2, as shown. In other words the height of each rib 8 above the interior surface of the bottom 2 of the base member 1 is at its greatest at each free-end of said rib 8, at or in the vicinity of a gutter 7, where the height of each rib above the interior surface 15 of the bottom 2 of the base 1 is at a minimum at or in the vicinity of a position substantially mid-way along the length dimension of each rib. As such, the ribs form a substantially level surface across the arcuate surface of the cooking surface 15. Opposed free ends of each rib 8, as well as the sides of each rib 8, are shaped (and specifically curved) so as to facilitate removal of oil, grease or fat which might be generated during cooking, rather than allowing such to collect at any point on the curved/shaped surface of the bottom 2.

The lid 20 is also of an integral construction and includes a top surface 21, of an arcuate or curved shape similar/complementary to that of the bottom 2 of the base 1 (and the base 1 in general). The top surface 21 terminates in a substantially downwardly-extending peripheral side wall 22, such side wall 22 having a peripheral or circumferential flange 23 extending substantially normally thereto at a location spaced-apart from the free end of the side wall 22, with such flange 23 itself then terminating in a downwardly-extending lip 24. In use the lip 4 of the base 1 and lip 24 of the lid 20 are of a complementary shape, and specifically profiled, to overlay one another with the lid being seated on the profiled seat of base flange 5.

Since the flange 23 is spaced from the free end of the side wall 22, there exists internally of the lid 20 a downwardly extending peripheral inner wall extension 25 which, in use, extends downwardly and internally of the lip 4 of the base 1, hence constituting a barrier against unwanted egress from the apparatus during cooking of steam, oil, grease and/or the like. The arrangement is such that steam, oil, grease etc. generated during cooking cannot exit the overall apparatus by reason of the overlapping lips 4 and 24 and wall extension 25 of the lid 20 and lid 20. Indeed, the manner in which the lid 20 is located on or is in engagement with the base 1 ensures that any condensation, whether such be water, oil, fat or the like, which is formed or generated within the overall apparatus during use/cooking is all directed back into the apparatus, more particularly the base, rather than being able to escape from the apparatus to be deposited, for example, in the oven. This represents a significant advance over known arrangements, which invariably allow for deposition of such unwanted material on the sides of the oven, necessitates regular cleaning thereof.

The lid 20 further includes a plurality of holes or apertures 26, to allow for egress of excess steam generated during heating. As shown the lid 20 also includes, preferably disposed substantially centrally thereof, a handle means 27 preferably formed as an integral part of the lid 20. It should be understood that the actual shape of the handle means 27 does not form part of the invention.

The arrangement in accordance with the present invention exhibits a number of practical advantages, in terms of effectiveness of operation, as outlined hereinafter.

Firstly the combination of base 1 and lid 20 minimises, if not removes altogether, the unsightly consequences of splattering of fat, grease and the like during cooking, with any such heated grease or fat being contained within the cooker at all times.

The raised ribs 8 serve to minimise surface contact of the rasher or rashers of bacon being cooked with the bottom surface of the base 1 of the cooking apparatus, thereby minimising the likelihood of the bacon adhering to or becoming at least partially stuck to the base 1, thereby avoiding charring, uneven cooking etc.

The inner wall extension 25 provided on the lower surface of the lid 20 allows for condensation of water, fat or the like created during cooking, with any condensed material to run down the lid 20 to be collected in the base 1, rather than exiting the cooker, as is the case with the majority of the prior art arrangements. In that regard it should be understood that, in the majority of the prior art arrangements, the configuration allows for condensate to actually exit the container and become deposited on the surface of the oven or the like cooking means, an unsightly result which gave rise to the need for cleaning of that oven or cooking means once cooking was complete.

The handle means 6 provided on the base 1, and that provided on the lid 20, facilitate handling of both pieces 1 and 20 of the overall apparatus, making such apparatus safer to use. The handle means 27 of the lid 20 allows for ready, safe separation—as by lifting—of the lid 20 from the base 1.

The arcuate shape of both the lid 20 and the base 1 allow for ready stacking of the apparatus in accordance with the present invention. This ability to be stacked is of significance in terms of maximising use of available “real estate” in a display stand or the like where such apparatus is being marketed.

Finally it should be understood that the aforegoing description refers merely to preferred embodiments of the invention and that variations and modifications will be possible thereto without departing from the spirit and scope of the invention, the ambit of which is to be determined from the following claims.

What is claimed is:

1. A cooking apparatus for the cooking of bacon in a microwave oven, the apparatus including a base member and a lid which is removably co-operable therewith, wherein:
the base member including a bottom and a peripheral side wall extending upwardly therefrom, the bottom of the base member having an inside cooking surface being of an arcuate shape when viewed in end elevation such that the cooking surface is higher at a centre portion of the arcuate shape than at an end portion, such that liquids can run from the centre portion to the end portion, the cooking surface of the base member further including a plurality of spaced-apart ribs extending substantially transversely thereof; and
wherein the lid includes a top and a peripheral side wall extending therefrom, wherein the lid, when viewed in end elevation, curves from the top to the peripheral side wall.

2. The apparatus as claimed in claim 1, wherein the base member and/or lid is constructed principally from a microwave transmissible material which is transparent to microwave radiation.

3. The apparatus as claimed in claim 2, wherein the peripheral sidewall of the base member terminates at the upper end thereof, in a peripheral lip depending outwardly and downwardly therefrom.

4. The apparatus as claimed in claim 3, wherein the free end of the peripheral lip of the base member includes a flange extending therefrom that is profiled to seat a corresponding profile on the lid.

5. The apparatus as claimed in claim 4, wherein the flange of the base member includes at least one pair of opposed handle means extending therefrom and along at least part of opposed edges of the base member.

6. The apparatus as claimed in claim 1, wherein the base member is of an arcuate shape when viewed from an end.

7. The apparatus as claimed in claim 6, wherein the lid, when viewed from an end, is of an arcuate shape that is complementary to the shape of the base member.

8. The apparatus as claimed in claim 1, wherein the peripheral side wall of the lid terminates in a peripheral lip depending downwardly therefrom.

9. The apparatus as claimed in claim 1, wherein the peripheral side wall of the lid includes a peripheral flange that is profiled to locate the lid onto the base member.

10. The apparatus as claimed in claim 1, wherein the lid includes a plurality of apertures therethrough.

11. The apparatus as claimed in claim 1, wherein the lid includes at least one gripping means.

12. The apparatus as claimed in claim 1, wherein the base member includes, at or in the vicinity of the junction of the bottom and the peripheral sides, and extending along at least part of at least two opposed sides thereof, a channel forming a gutter.

13. The apparatus as claimed in claim 1, wherein the ribs extend across at least part of the cooking surface of the base member and in the same direction as an arc defined by the arcuate shape of the cooking surface.

14. The apparatus as claimed in claim 13, wherein the height of each rib above the inside cooking surface of the bottom of the base member is greatest at or in the vicinity of opposed ends of each rib, than at or in the vicinity of the midpoint of the rib, such that the rib forms a substantially level surface on the arcuate cooking surface.
